(19) United States
(12) Patent Application Publication
(10) Pub. No.: US 2018/0330010 A1
(43) Pub. Date: Nov. 15, 2018

(54) INFORMATION PROCESSING APPARATUS, INFORMATION PROCESSING METHOD, AND RECORDING MEDIUM RECORDING INFORMATION PROCESSING PROGRAM

(71) Applicant: FUJITSU LIMITED, Kawasaki-shi (JP)

(72) Inventors: Yohei Seki, Kawasaki (JP); Toshihiro Kodaka, Yokohama (JP); Tomohiro OHTAKE, Kawasaki (JP)

(73) Assignee: FUJITSU LIMITED, Kawasaki-shi (JP)

(21) Appl. No.: 15/970,195

(22) Filed: May 3, 2018

(30) Foreign Application Priority Data
May 12, 2017 (JP) 2017-095749

(51) Int. Cl. G06F 17/30; G05B 15/02; G06F 9/445; G06F 9/54

(52) U.S. Cl. CPC G06F 17/30964; G06F 17/30997; G06F 9/541; G06F 9/44505; G05B 15/02

(57) ABSTRACT

An information processing apparatus includes: a memory; and a processor coupled to the memory, wherein the processor: acquires a plurality of functionalities that a system uses to implement a predetermined idea; searches functionality information, which associates devices with functionalities and associates application programming interfaces (APIs) with functionalities, for one or more devices or one or more APIs having the respective acquired functionalities; generates a plurality of first combinations including at least two ones of the one or more devices and the one or more APIs and having the functionalities; assesses each of the first combinations in accordance with an assessment function in which the first combinations are weighted with particular elements; and presents the first combinations in accordance with assessment values obtained in assessment to select a first combination to be used in the system.

### CROSS-REFERENCE TO RELATED APPLICATION

This application is based upon and claims the benefit of priority of the prior Japanese Patent Application No. 2017-095749, filed on May 12, 2017, the entire contents of which are incorporated herein by reference.

### FIELD

The embodiment discussed herein is related to an information processing apparatus or the like.

### BACKGROUND

When a system is developed to implement an idea, a device or an application program interface (API) having a functionality of the idea is searched for and the devices or APIs, found in searching, are combined to develop.

Related art is disclosed in Japanese Laid-open Patent Publication No. 2014-153797.

### SUMMARY

According to an aspect of the embodiments, an information processing apparatus includes: a memory; and a processor coupled to the memory, wherein the processor: acquires a plurality of functionalities that a system uses to implement a predetermined idea; searches functionality information, which associates devices with functionalities and associates application programming interfaces (APIs) with functionalities, for one or more devices or one or more APIs having the respective acquired functionalities; generates a plurality of first combinations including at least two ones of the one or more devices and the one or more APIs and having the functionalities; assesses each of the first combinations in accordance with an assessment function in which the first combinations are weighted with particular elements; and presents the first combinations in accordance with assessment values obtained in assessment to select a first combination to be used in the system.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram of an information processing apparatus;

FIG. 2A illustrates an example of a process of the information processing apparatus;

FIG. 2B illustrates an example of a process of the information processing apparatus;

FIG. 3 illustrates an example of a data structure of a functionality database (DB);

FIG. 4 illustrates an example of a data structure of a device DB;

FIG. 5 illustrates an example of a data structure of an API DB;

FIG. 6 illustrates an example of a data structure of a device-functionality DB;

FIG. 7 illustrates an example of a data structure of an API-functionality DB;

FIG. 8 illustrates an example of a data structure of a device-API weight DB;

FIG. 9 illustrates an example of calculation of a weight between the device and API;

FIG. 10 illustrates a weight calculation process;

FIG. 11 illustrates an example of a combination determination process;

FIG. 12 is a functional block diagram of the information processing apparatus;

FIG. 13 illustrates an example of an alternative functionality search process;

FIG. 14 illustrates an example of a data structure of a functionality conversion DB;

FIG. 15 illustrates an example of an alternative functionality search;

FIGS. 16A and 16B illustrate an example of a combination determination process including the alternative functionality search process;

FIG. 17 is a functional block diagram of the information processing apparatus;

FIG. 18 illustrates an example of an alternative functionality search adjustment;

FIG. 19 illustrates an alternative functionality search adjustment process; and

FIG. 20 illustrates an example of a computer that executes an information processing program.

### DESCRIPTION OF EMBODIMENT

For example, a device or an API is searched in a web search system which performs a web search when a user enters a keyword related to a functionality. The web search system includes a web search system of Google, for example.

For example, there are device information presentation systems that present, in response to a user's request, information concerning a device that may satisfy the user's request. In such a device information presentation system, a process module enabled to acquire desired output results specified in the user's request is extracted from a process module database (DB). By comparing an input condition of the extracted process module with an output condition of each device, one or more devices providing an output usable as an input to the extracted process module is extracted from a device DB. A virtual device including a combination of the extracted one or more devices and the extracted process module is generated, and information concerning the virtual device is presented to the user as the search results.

When a certain idea is implemented, it may be difficult to find out an optimum combination of a device and an API having a functionality included in the idea.

In a web search system, every web page is searched for over the web, and undesired web pages may often be searched for. It may be difficult to find out a combination of a device and an API meeting the user's purposes. For example, specifications of input and output of each device and each API or the like are compared with each other, and compatibility between combinations is checked. It may be difficult to find out an optimum combination.

In the device information presentation system, the specifications of input and output of each device and each API or the like are compared with each other, and compatibility between combinations is checked. It may be difficult to find out an optimum combination.

For example, an optimum combination of a device and an API having a functionality that implements an idea may be effectively searched for.

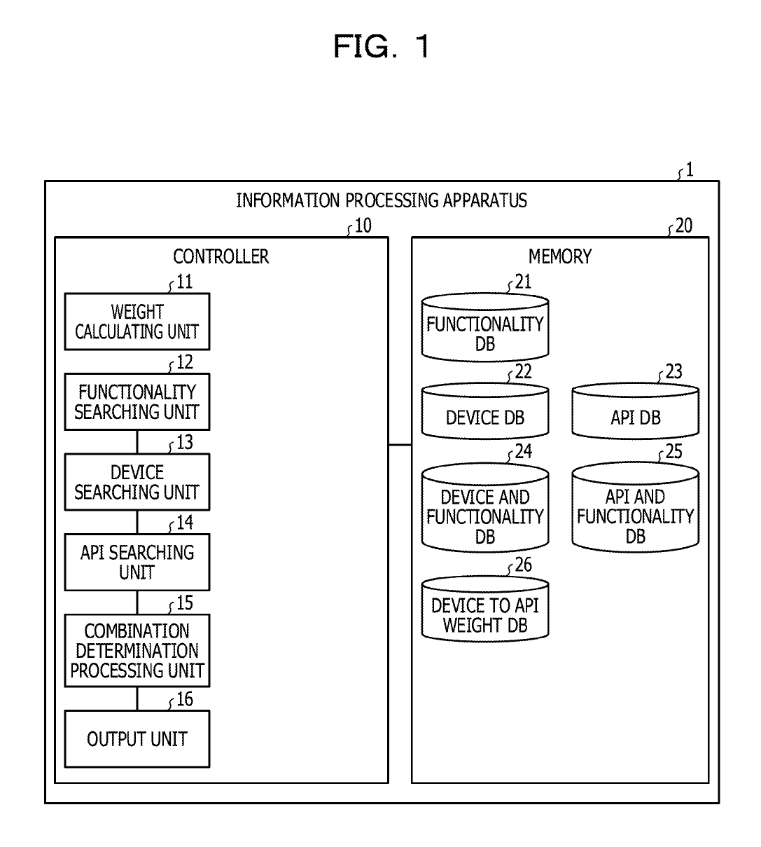

FIG. 1 is a functional block diagram of an information processing apparatus. When a system is developed to implement an idea, the information processing apparatus 1 of FIG. 1 presents an optimum combination of a device and API in accordance with an assessment function that weights combinations of devices and APIs having each of the functionalities of the idea with particular elements. For example, the idea may be “a system that switches an air-conditioner on if a finger draws a circle when the room temperature exceeds 29 degrees ° C.”, or “a system that reproduces music in addition to music played, depending on location”. The assessment function is a function which weights each of a pair of a device and a device, a pair of a device and an API, a pair of an API and an API respectively with particular elements and sums the weight values on a per combination basis.

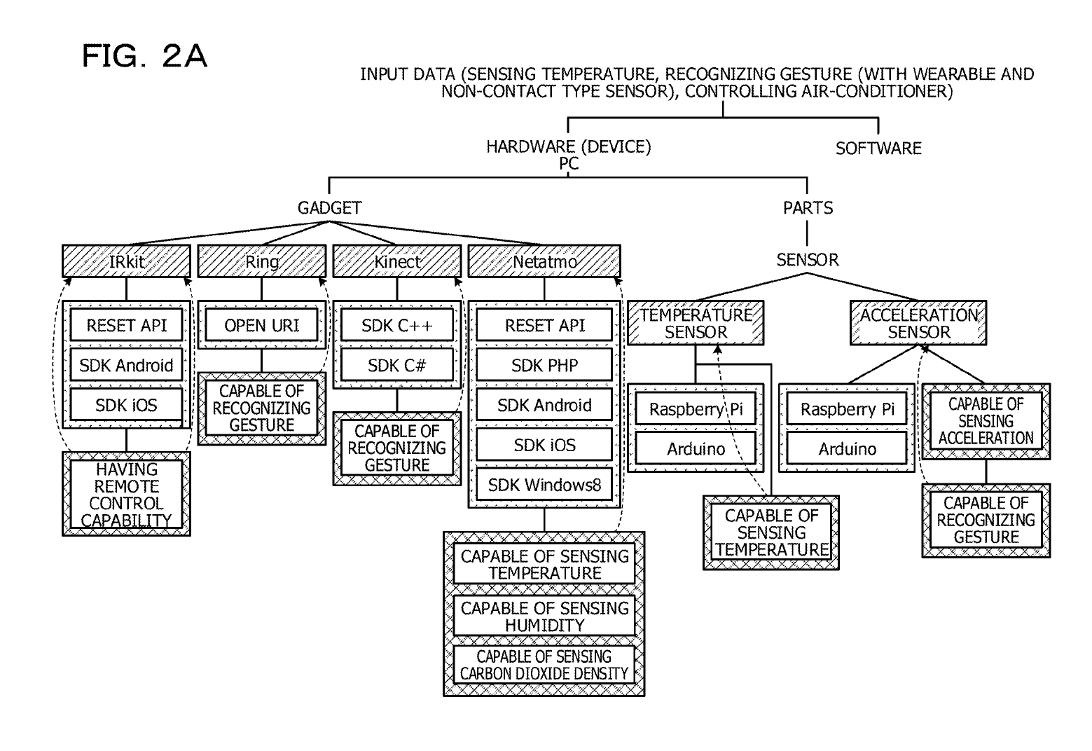

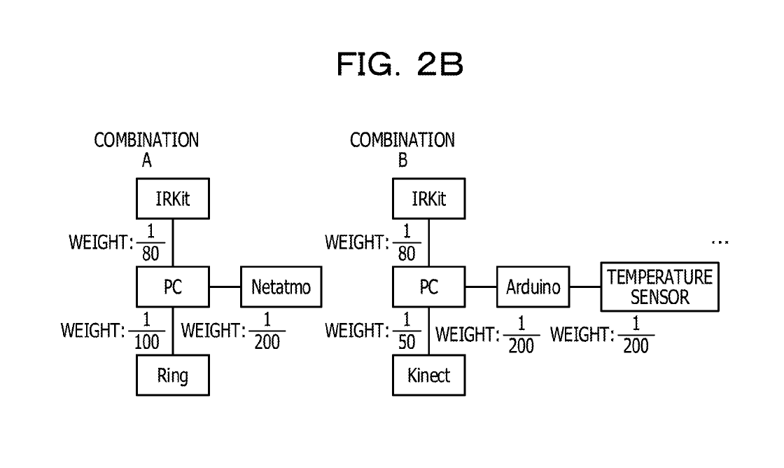

FIG. 2A and FIG. 2B illustrate examples of processes of the information processing apparatuses. Referring to FIG. 2A, a graph structure indicates a link between a device and a functionality responsive to input data when idea data is input as the input data. For example, the idea data input as the input data may be “a system that switches an air-conditioner on if a finger draws a circle when the room temperature is 29 degrees OC”. The processes of FIG. 2A and FIG. 2B may be implemented by a variety of DBs to be discussed below.

Referring to FIG. 2A, the information processing apparatus 1 extracts multiple functionalities from the idea data. The functionalities implemented by the idea “sensing temperature”, “recognizing gesture”, and “controlling an air” are extracted.

The information processing apparatus 1 searches for a device or an API having each extracted functionality. “Netatmo” and a “temperature sensor” indicating a device that acquires weather information via a sensor are acquired as a device or an API having the functionality of “sensing temperature”. “Ring” indicating a ring wearable terminal, “Kinect” indicating an API recognizing gesture, and an “acceleration sensor” are acquired as a device or an API having the functionality of “recognizing gesture”. “IRKit” indicating an infrared remote control device with WiFi function is acquired as a device or an API having the functionality of “controlling an air”.

Referring to FIG. 2B, when a system is developed to implement an idea, the information processing apparatus 1 searches for a combination of a device and an API having each functionality of the idea. For example, searched as a combination A are “PC” and “Netatmo” as a pair having the functionality of “sensing temperature”, “PC” and “Ring” as a pair having the functionality of “recognizing gesture”, and “PC” and “IRKit” as a pair having the functionality of “controlling an air”. Searched as a combination B are “PC” and “Arduino” and a “temperature sensor” as a combination having the functionality of “sensing temperature”, “PC” and “Kinect” as a pair having the functionality of “recognizing gesture”, and “PC” and “IRKit” as a pair having the functionality of “controlling an air”.

The information processing apparatus 1 calculates an assessment value through an assessment function such that each combination is weighted with a particular element on a per combination basis. The assessment function is a function that weights each pair of a device and a device, a device and an API, and an API and an API with a particular element and sums the weight value on a per combination basis. The particular element may be the number of uses of each pair in the past, for example. The weight value is the reciprocal of an element value of a particular element (the number of uses of a pair used in the past). The larger the number of uses of a pair is, the smaller the weight value of the pair is. Accordingly, as the assessment value of the assessment function for a combination is smaller, the assessment of the combination becomes higher. The number of past uses may be a count of pairs of a device of an API used in the past on an IoT DIY site. For example, the weight for the pair of PC and IRKit is 1/80, the weight for the pair of PC and Netatmo is 1/200, and the weight for the pair of PC and Ring is 1/100. The weight for the pair of PC and Kinect is 1/50, the weight for the pair of PC and Aurduino is 1/200, and the weight for the pair of Arduino and the temperature sensor is 1/200.

The assessment value of the combination A is calculated by summing 1/80, 1/100, and 1/200, and is thus 22/800. The assessment value of the combination B is calculated by summing 1/80, 1/50, 1/200, and 1/200, and is thus 34/800.

The information processing apparatus 1 presents an optimum combination based on the assessment function. Since the combination A is smaller than the combination B in assessment value, the information processing apparatus 1 determines that the combination A is an optimum combination. The information processing apparatus 1 thus presents the combination A as an optimum combination.

In this way, the information processing apparatus 1 finds out the optimum combination of a device and an API having the function of an idea that is desired to be implemented.

Turning back to FIG. 1, the information processing apparatus 1 includes a controller 10 and a memory 20.

The controller 10 is an electronic circuit, such as a central processing unit (CPU). The controller 10 includes an internal memory that stores a program defining the procedure of each process and control data, and performs a variety of processes using them. The controller 10 includes a weight calculating unit 11, a functionality searching unit 12, a device searching unit 13, an API searching unit 14, a combination determination processing unit 15, and an output unit 16.

The memory 20 is a semiconductor memory, such as a random access memory (RAM), or a flash memory, or a storage device, such as a hard disk or an optical disk. The memory 20 includes a functionality database (DB) 21, a device DB 22, an API DB 23, a device-functionality DB 24, an API-functionality DB 25, and a device-API weight DB 26. The functionality DB 21 stores information related to a function that an idea is supposed to have. The device DB 22 stores information of a device having a function. The API DB 23 stores information of an API having a functionality. The device-functionality DB 24 stores an association between a device and a functionality. The API-functionality DB 25 stores an association between an API and a functionality. The device-API weight DB 26 stores a weight for each of a pair of a device and a device, a pair of a device and an API, a pair of an API and an API.

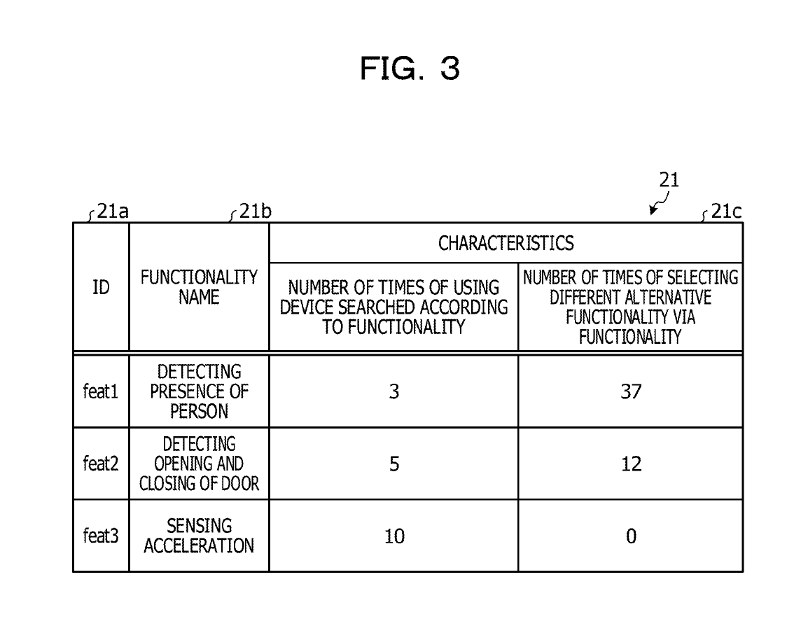

FIG. 3 illustrates an example of a data structure of the functionality DB 21. Referring to FIG. 3, the functionality DB 21 stores an identifier (ID) 21a, a functionality name 21b, and characteristics 21c in association with each other. The ID 21a is an identifier identifying a functionality. The functionality name 21b is the name of a functionality. The characteristics 21c store a variety of characteristics of each functionality. For example, the characteristics 21c store the number of uses of a device or an API recommended in view of functionality as characteristics. The count of selections of an alternative function via one functionality is stored as the characteristics. The contents stored in the characteristics 21c are not limited to this piece of information. The characteristics 21c may be omitted when they are not used. The functionality DB 21 may be generated prior to a service operation of the information processing apparatus 1.

As an example, if the ID 21a is “feat 1”, “detecting presence of person” is stored as the functionality name 21b. If the ID 21a is “feat 2”, “detecting opening and closing of door” is stored as the functionality name 21b.

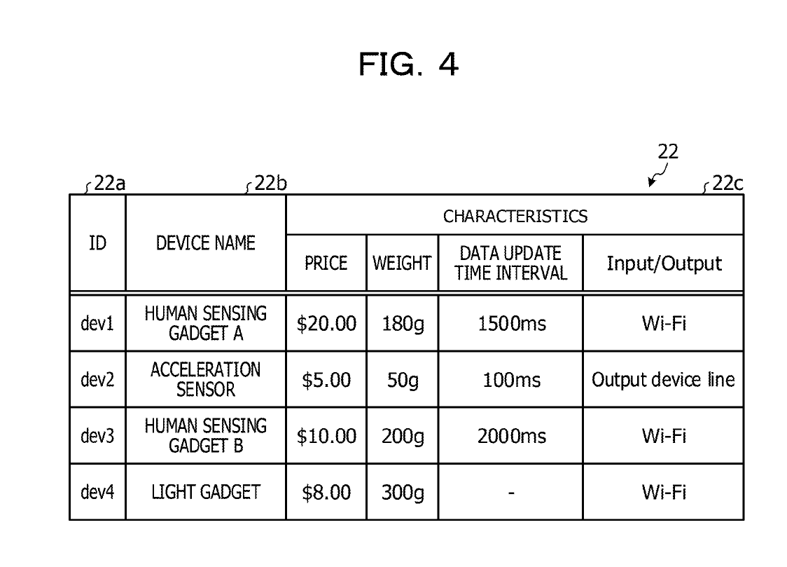

FIG. 4 illustrates the data structure of the device DB 22. Referring to FIG. 4, the device DB 22 stores an ID 22a, a device name 22b, and characteristics 22c in association with each other. The ID 22a is an identifier identifying a device. The device name 22b is a device name. The characteristics 22c store a variety of characteristics of the device. For example, the characteristics 22c stores the price, the weight, the data update time interval, and the type of an input and output of the device as characteristics. The contents stored in the characteristics 22c are not limited to these. Note that the device DB 22 is produced prior to the service operation of the information processing apparatus 1.

If the ID 22a is “dev1”, for example, a “human sensing gadget A” is stored as the device name 22b. If the ID 22a is “dev2”, an “acceleration sensor” is stored as the device name 22b.

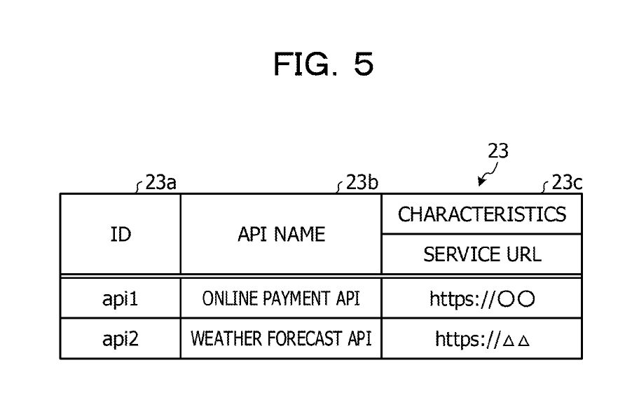

FIG. 5 illustrates the data structure of the API DB 23. Referring to FIG. 5, the API DB 23 stores an ID 23a, an API name 23b, and characteristics 23c in association with each other. The ID 23a is an identifier identifying an API. The API name 23b is the name of the API. The characteristics 23c store a variety of characteristics. For example, the characteristics 23c stores as a service uniform resource locator (URL) of a service that provides the API as characteristics. When the characteristics 23c are not used, the characteristics 23c may be omitted. The API DB 23 may be produced before the service operation of the information processing apparatus 1.

For example, if the ID 23a is “api1”, an “online payment API” is stored as the API name 23b. If the ID 23a is “api2”, a “weather forecast API” is stored as the API name 23b.

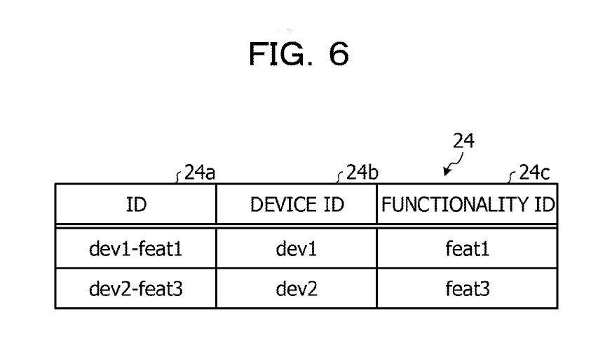

FIG. 6 illustrates the data structure of the device-functionality DB 24. As illustrated in FIG. 6, the device-functionality DB 24 stores an ID 24a, a device ID 24b, and a functionality ID 24c in association with each other. The ID 24a is an identifier identifying a device-functionality. The device-functionality indicates an association between the device and the functionality, and means that the device has that functionality. The device ID 24b is the ID of the device. The functionality ID 24c is the ID of the functionality. The device-functionality DB 24 may be produced before the service operation of the information processing apparatus 1.

As an example, if the ID 24a is “dev1-feat1”, “dev1” is stored as the device ID 24b, and “feat1” is stored as the functionality ID 24c.

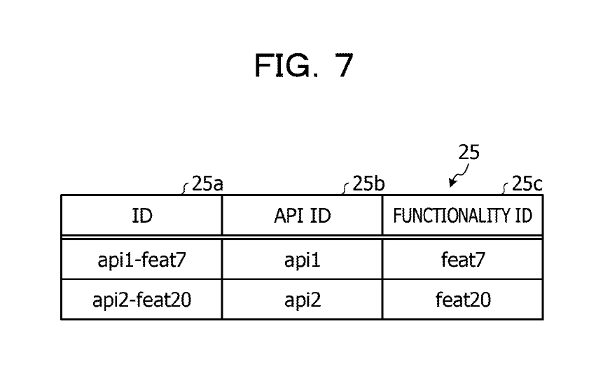

FIG. 7 illustrates the example of a data structure of the API-functionality DB 25. Referring to FIG. 7, the API-functionality DB 25 stores an ID 25a, an API ID 25b, and a functionality ID 25c in association with each other. The ID 25a is an identifier identifying an API and functionality. The API-functionality indicates an association between the API and the functionality, and means that the API has that functionality. The API ID 25b is the ID of the API. The functionality ID 25c is the ID of the functionality. Further, the API-functionality DB 25 is produced prior to the service operation of the information processing apparatus 1.

As an example, if the ID 25a is “api1-feat7”, “api1” is stored as the API ID 25b, and “feat7” is stored as the functionality ID 25c.

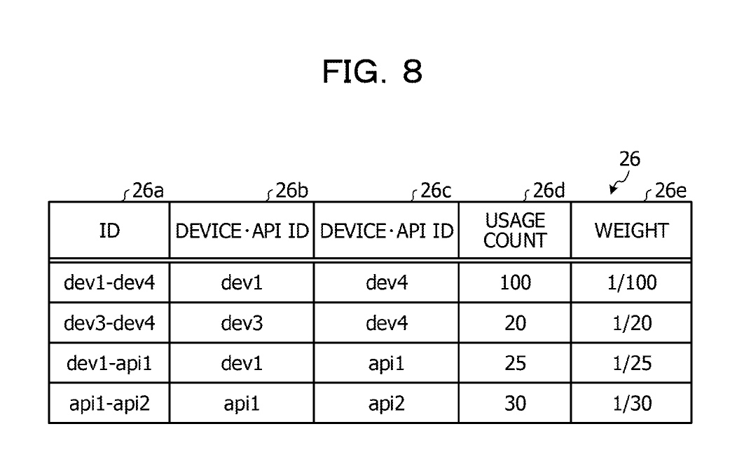

FIG. 8 illustrates the example of a data structure of the device-API weight DB 26. Referring to FIG. 8, the device-API weight DB 26 stores an ID 26a, a device-API ID 26b, a device-API ID 26c, a usage count 26d, and a weight 26e in association with each other. The ID 26a is an identifier identifying a pair of the device-API and the device-API. The device-API indicates a device or an API, for convenience of explanation. The device-API ID 26b indicates the ID of one of the device-API in the pair, and the device-API ID 26c indicates the ID of the other of the device-API in the pair. The usage count 26d indicates a past usage count of the pair. The weight 26e is a weight value of the pair. For example, the weight 26e is the reciprocal of the usage count. The device-API weight DB 26 is produced by the weight calculating unit 11 before the service operation of the information processing apparatus 1, but may alternatively be re-produced periodically or non-periodically after the service operation. The past usage count may be obtained by counting the number of pairs of devices and APIs used in the past on the DIY sites of the IoT system.

If the ID 26a is “dev1-dev4”, for example, “dev1” is stored as the device-API ID 26b, and “dev4” as the device-API ID 26c. “100” is stores as the usage count 26d, and “ 1/100” is stored as the weight 26e.

Turning back to FIG. 1, the weight calculating unit 11 calculates the weight for the pair of the device or the API and the device or the API. For example, the weight calculating unit 11 crawls on the DIY sites of the Iot system and acquires a device and an API used in a given project on a given DIY site. Using the acquired device and API, the weight calculating unit 11 produces a pair of the device or the API and the device or the API. The weight calculating unit 11 counts the number of uses in the project on each produced pair. The weight calculating unit 11 calculates the reciprocal of the count on each produced pair as the weight.

The weight calculating unit 11 associates, on a per pair basis, one of the device and the API, the other of the device and the API, the count value, and the weight value, and stores these pieces of information in association with each other on the device-API weight DB 26.

When multiple functionalities contained in an idea are input, the functionality searching unit 12 performs a searching operation to determine whether each of the input functionalities is registered in the functionality DB 21. For example, the functionality searching unit 12 checks an input functionality against the functionality name 21b in the functionality DB 21 to determine whether the input functionality matches the functionality name 21b. A match includes not only the case of full matching, but also the case of partial matching and the case in which the functionality is similar in sense to the functionality name 21b. This determination may be performed on a per input functionality basis. If all the input functionalities match, the functionality searching unit 12 outputs the input functionalities to the device searching unit 13 and the API searching unit 14. The functionality searching unit 12 receives the functionalities included in the idea, but what the functionality searching unit 12 receives is not limited to the functionalities included in the idea. The functionality searching unit 12 may also receive the idea itself. To receive the idea itself, the functionality searching unit 12 may acquire a functionality included in the idea using language analysis such as morphological analysis, from the received idea.

The device searching unit 13 searches for a device having a functionality. For example, the device searching unit 13 searches the device-functionality DB 24 for a device corresponding to a functionality output from the functionality searching unit 12.

The API searching unit 14 searches for an API having a functionality. For example, the API searching unit 14 searches the API-functionality DB 25 for an API corresponding to a functionality output from the functionality searching unit 12.

The combination determination processing unit 15 determines a combination of a device and an API for use in implementing the idea.

For example, the combination determination processing unit 15 generates a pair of one of the device and the API and one of the device and the API using the device corresponding to the functionality searched by the device searching unit 13 and the API corresponding to the functionality searched by the API searching unit 14. The combination determination processing unit 15 stores, in a temporary storage region of the memory 20, a connectable pair out of the generated pairs. For example, the combination determination processing unit 15 extracts, out of the pairs, a pair of one of the devices and the APIs and one of the devices and the APIs, which is connectable in terms of an interface, platform, a software development kit (SDK) or the like, and stores the extracted pair. The interface, the platform, and the SDK supported by the device or the API may be set as characteristics on DBs. For example, in the case of the device, the interface, the platform, and the SDK may be set in the characteristics 22c of the device DB 22. In the case of the API, the interface, the platform, and the SDK may be set in in the characteristics 23c on the API DB 23. The combination determination processing unit 15 references the device⋅API weight DB 26, and acquires the weight for the connectable pair.

The combination determination processing unit 15 generates a combination of the device and the API having each functionality included in the idea. The combination determination processing unit 15 sums the weights corresponding to the pairs contained in each generated combination for each generated combination. The combination determination processing unit 15 compares the sums of the combinations, and arranges the combinations in the order of a smaller weight sum to a larger weight sum. For example, on each combination of the device or the API having each functionality included in the idea, the combination determination processing unit 15 determines as an optimum combination a combination having a minimum assessment value (sum of the weight values) via the assessment function that weights the combinations with particular elements.

The output unit 16 outputs the combination that the combination determination processing unit 15 has determined. For example, the output unit 16 outputs the combinations in the order of from a smaller weight sum to a larger weight sum. Alternatively, for example, the output unit 16 outputs the combinations in the order of from the optimum combination. Alternatively, the output unit 16 may present only the combination having a small weight sum.

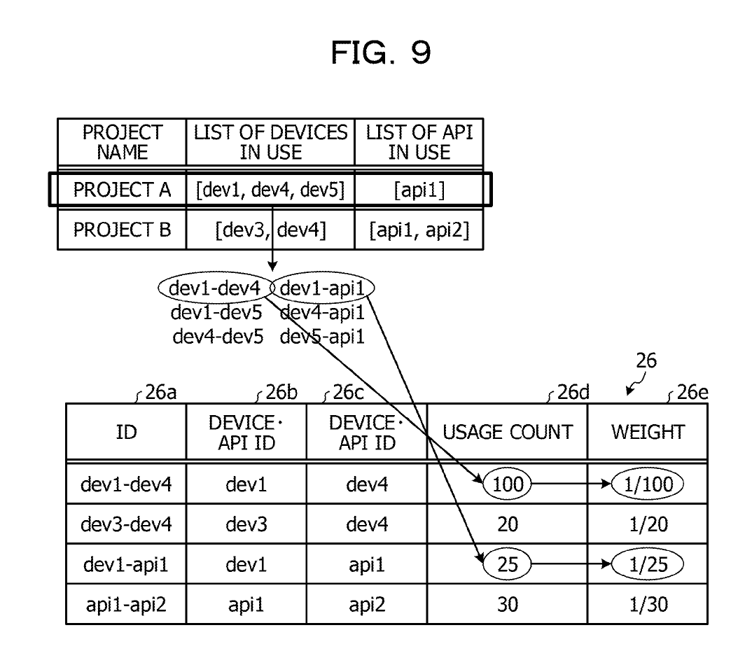

FIG. 9 illustrates how the weight between the device and API is calculated.

As illustrated in the upper portion of FIG. 9, a list of devices used in the past and a list of APIs used in the past may be registered on each project page on the DIY sites of the IoT system. For example, if a project name is “project A”, “dev1, dev4, and dev5” are registered as the devices used. Registered as an API used in the past is “api1”. If the project name is “project B”, “dev3 and dev4” are registered as the devices used in the past, and “api1 and api2” are registered as the APIs used in the past.

As illustrated in the lower portion of FIG. 9, the weight calculating unit 11 crawls on the DIY sites of the IoT system and acquires the device and the API used in a project on a DIY site. Using the device and the API acquired, the weight calculating unit 11 generates pairs, each pair of one of the device and the API and one of the device or the API. For example, the pairs generated in the project A are “dev1-dev 4”, “dev1-dev5”, “dev4-dev5”, “dev1-api1”, “dev4-api1”, and “dev5-api1”.

The weight calculating unit 11 counts the number of uses for each of the generated pairs in the project. For example, the weight calculating unit 11 increments the value of the generated pair “dev1-dev4” by one and sets the incremented value in the usage count 26d corresponding to “dev1-dev4” in the device-API weight DB 26. As another example, the weight calculating unit 11 increments the value of the generated pair “dev1-api1” by one and sets the incremented value in the usage count 26d corresponding to “dev1-api1” in the device. API weight DB 26.

The weight calculating unit 11 calculates as a weight the reciprocal of the usage count for each generated pair. Since “dev1-dev4” has “100” in the usage count 26d, the weight calculating unit 11 calculates as a weight a reciprocal of the usage count, which is “ 1/100”, and sets 1/100 in the weight 26e on the device-API weight DB 26. Since “dev1-api1” has “25” in the usage count 26d, the weight calculating unit 11 calculates as a weight a reciprocal of the usage count, which is 1/25, and sets 1/25 in the weight 26e on the device-API weight DB 26.

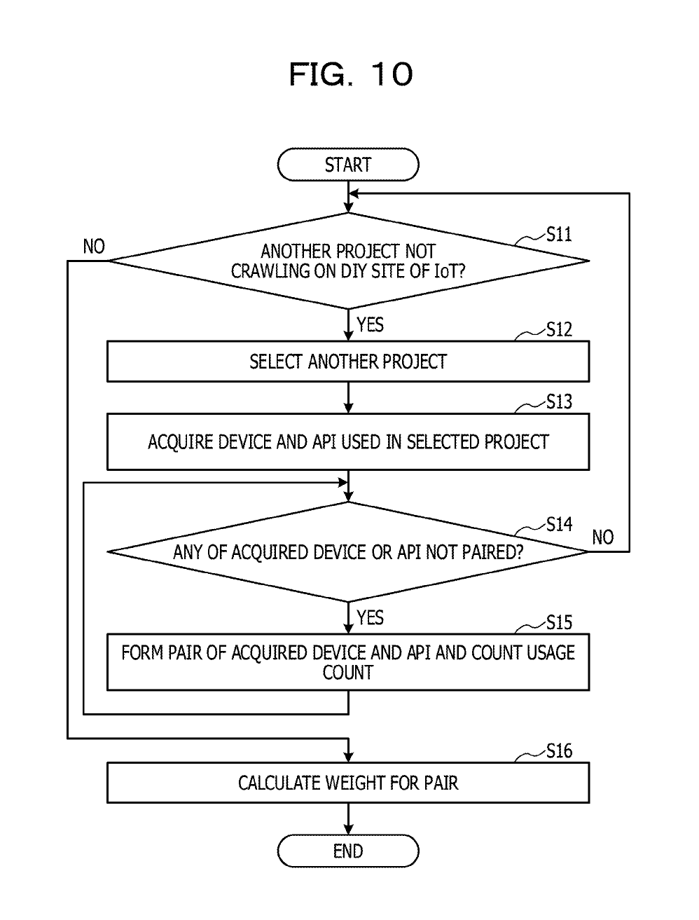

FIG. 10 illustrates an example of the weight calculation process. Referring to FIG. 10, the weight calculation of each pair is performed using an DIY site of a IoT system.

Referring to FIG. 10, the weight calculating unit 11 having received a weight calculation request determines whether another project not crawling on the DIY sites of the IoT system is present (operation S11). If the another project not crawling is present (yes branch from operation S11), the weight calculating unit 11 select the other project (operation S12). The weight calculating unit 11 acquires a device and an API used in the selected another project (operation S13).

The weight calculating unit 11 determines whether another acquired device and API is not paired (operation S14). If the another device and the API unpaired is present (yes branch from operation S14), the weight calculating unit 11 generates a pair of the device and the API acquired, and counts the number of pairs generated (operation S15). For example, the weight calculating unit 11 increments the generated pair by only one. For example, the weight calculating unit 11 sets the number of times of incremented by only one in the usage count 26d for the corresponding pair on the device. API weight DB 26. The weight calculating unit 11 proceeds to operation S14 to determine the device or the API that is not paired.

If the weight calculating unit 11 determines that there is neither device nor API that is unpaired (no branch from operation S14), the weight calculating unit 11 returns to operation S11 to determine another project.

If the weight calculating unit 11 determines in operation S11 that there is no project crawling (no branch from operation S11), the weight calculating unit 11 calculates the weight for each pair (operation S16). For example, the weight calculating unit 11 sets the reciprocal of the usage count 26d in the weight 26e for each pair (the ID 26a) in the device-API weight DB 26. If the usage count 26d is 0, the weight calculating unit 11 sets the weight 26e to 0. The weight calculating unit 11 thus ends the weight calculation process.

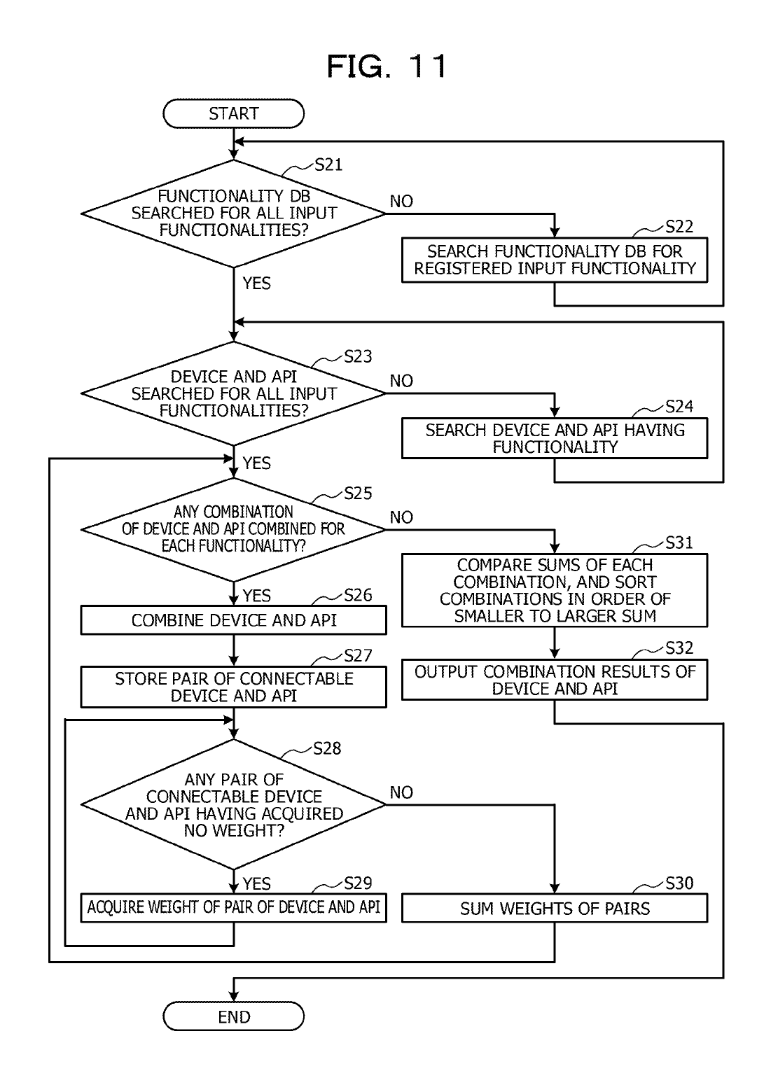

FIG. 11 illustrates an example of a combination determination process.

Referring to FIG. 11, the functionality searching unit 12 having received multiple functionalities contained in the idea determines whether the functionality DB 21 has been searched for all the input functionalities (operation S21). If the functionality searching unit 12 determines that the functionality DB 21 has not been searched for all the input functionalities (no branch from operation S21), the functionality searching unit 12 determines whether the input functionality has been registered on the functionality DB 21 (operation S22). The functionality searching unit 12 returns to operation S21 to determines the input functionality.

If the functionality searching unit 12 determines that the functionality DB 21 has been searched for all the input functionalities (yes branch from operation S21), the device searching unit 13 determines whether the device has been searched for all the input functionalities. The API searching unit 14 determines whether the API has been searched for all the input functionalities (operation S23). For example, the device searching unit 13 searches the device-functionality DB 24 for a device having each of the functionalities regarding each of all of the functionalities. The API searching unit 14 searches the API-functionality DB 25 for an API having each of the functionalities regarding each of all of the functionalities.

If it is determined that the device or the API has not been searched for each of all the input functionalities (no branch from operation S23), the device searching unit 13 searches for a device having the corresponding functionality. The API searching unit 14 searches for an API having the corresponding functionality (operation S24). The API searching unit 14 returns to operation S23 to search for an unprocessed functionality.

If it is determined that the device or the API has been searched for each of all the input functionalities (yes branch from operation S23), the combination determination processing unit 15 determines any of the devices and APIs corresponding to each of the functionalities are not combined (operation S25). If the combination determination processing unit 15 determines that any of the devices and APIs not combined is present (yes branch from operation S25), the combination determination processing unit 15 combines a device and an API that have not been yet combined (operation S26).

The combination determination processing unit 15 stores a combination of connectable device and API in a temporary storage region of the memory 20 (operation S27). For example, the combination determination processing unit 15 stores, in the memory 20, pairs, each pair of one of devices and APIs and one of devices and APIs which are connectable. Whether the device or the API is connectable or not is determined, for example, using the characteristics 22c in the device DB 22 and the characteristics 23c in the API DB 23. The combination determination processing unit 15 then proceeds to operation S28.

In operation S28, the combination determination processing unit 15 determines whether any of the pairs of connectable devices and APIs has not acquired a weight (operation S28). If the combination determination processing unit 15 determines that any pair having no weight acquired is present (yes branch from operation S28), the combination determination processing unit 15 acquires the weight for the pair of the device and API from the device-API weight DB 26 (operation S29). The combination determination processing unit 15 returns to operation S28 to perform the weight acquisition determination operation on the pair.

If the combination determination processing unit 15 determines that there is no pair that does not acquire a weight (no branch from operation S28), the combination determination processing unit 15 sums the weights of each of the pairs of the combinations of all the functionalities (operation S30). The combination determination processing unit 15 returns to operation S25 to combine the devices and APIs.

If the combination determination processing unit 15 determines in operation S25 that there are none of the device and APIs that are to be combined (no branch from operation S25), the combination determination processing unit 15 compares the weight sums of each of the combinations. The combination determination processing unit 15 sorts the combination results in the order of from a smaller to a larger weight sum (operation S31).

The output unit 16 outputs the combination results of devices and APIs (operation S32). The output unit 16 ends the combination determination process.

The assessment function may be a function which weights a pair of a device and a device, a pair of a device and an API, a pair of an API and an API with particular elements, and sums the weight values on a per combination basis. The particular element may be, for example, a usage count of uses of a pair in the past. The particular element is not limited to this. For example, the particular element may be the usage count of uses of a pair in the past three months. For example, the particular element may be information as to whether the SDK or programming language of the same type is used, information as to whether the same platform or SDK is used, or information as to whether the same type of communication interface is used. For example, the particular element may be information concerning price, magnitude (size and weight), installation location, whether water-proofed design is adopted or not, the degree of difficulty or complexity, or response speed. For example, the particular element may be a combination of these factors.

For example, the assessment function may be a function that weights combinations with particular elements. The particular element herein refers to the number of devices or APIs contained in a combination. As the number of devices or APIs contained in a combination increases, weighting may be performed such that the combination is set to be more difficult to recommend.

The information processing apparatus 1 acquires multiple functionalities used in the system that implements a predetermined idea. The information processing apparatus 1 searches the device-functionality DB 24 and the API-functionality DB 25 for a device or an API having each of the acquired functionalities. The information processing apparatus 1 generates multiple combinations of devices and APIs, each having multiple functionalities. The information processing apparatus 1 assesses each of the combinations via the assessment function that weights the combinations with the particular elements. The information processing apparatus 1 presents a combination having a predetermined assessment, based on the assessment value obtained in the assessment operation. In this operation, the information processing apparatus 1 efficiently finds out an optimum combination of the device and the API having a desired functionality when the implementation of a given idea is desired.

On each of the generated multiple combinations, the information processing apparatus 1 assesses each combination using the assessment function that weights the combinations with the particular elements. The particular elements includes at least one of the usage frequency of each of the pairs of devices and APIs, the number of pairs of devices and APIs contained in each of the combinations, and the interface of each pair. In this arrangement, the information processing apparatus 1 efficiently finds out an optimum combination via assessing with the assessment function that weights the combinations of devices or APIs with the particular elements.

The information processing apparatus 1 may search for a device or an API having each of the functionalities contained in the idea, and may determine the combinations of searched devices and APIs. For example, a device or an API having a functionality may not be hit, or the searched device or API, found in the search, may fail to satisfy quality characteristics. In such a case, the information processing apparatus 1 converts a particular function used in the search into another functionality, and may search for a device or an API having the another functionality. For example, if none of the device or API having the other functionality, the information processing apparatus 1 may convert the another functionality into still another functionality. The information processing apparatus 1 may recursively converts the functionality in this way.

For example, the information processing apparatus 1 thus converts a particular functionality used in the search into another functionality, and searches for a device or an API having the another functionality.

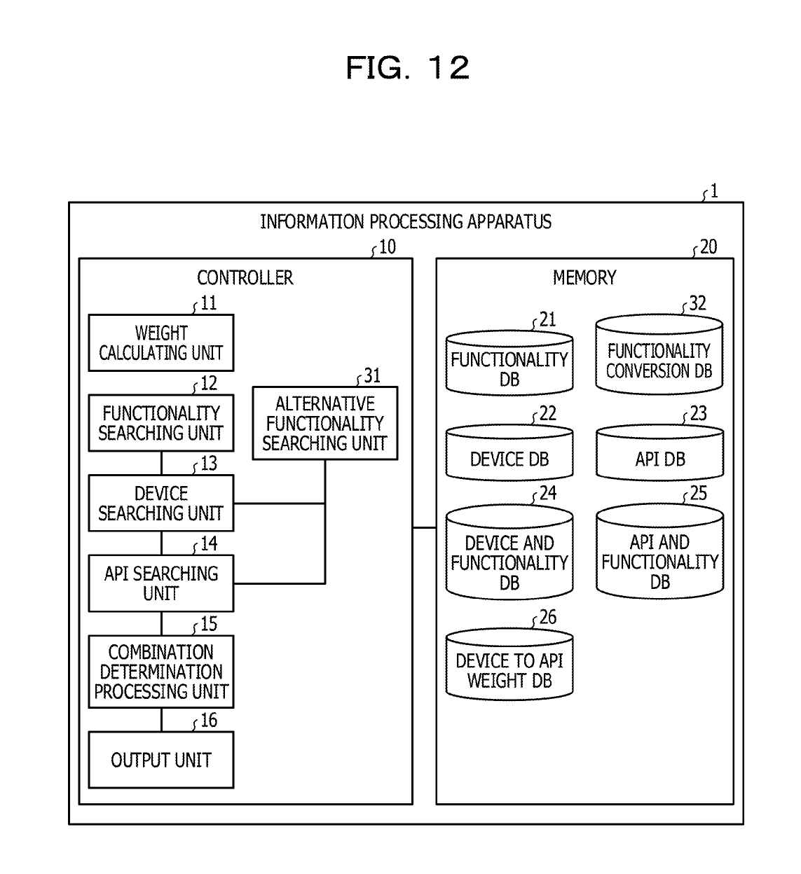

FIG. 12 is a functional block diagram of an information processing apparatus. Elements identical to those of the information processing apparatus 1 of FIG. 1 are designated with the same reference numerals, and the discussion of the configuration and operations identical to those of the information processing apparatus 1 may be omitted herein. The information processing apparatus of FIG. 12 is different from the information processing apparatus 1 of FIG. 1 in that the information processing apparatus of FIG. 12 additionally includes an alternative functionality searching unit 31 and a functionality conversion DB 32.

A device or an API having a particular functionality may be difficult to search for, or a device or an API having the particular functionality, if successfully hit, may fail to satisfy predetermined quality characteristics. In such a case, the alternative functionality searching unit 31 performs the following process. For example, the alternative functionality searching unit 31 converts the particular functionality into another functionality different from the particular functionality using the functionality conversion DB 32.

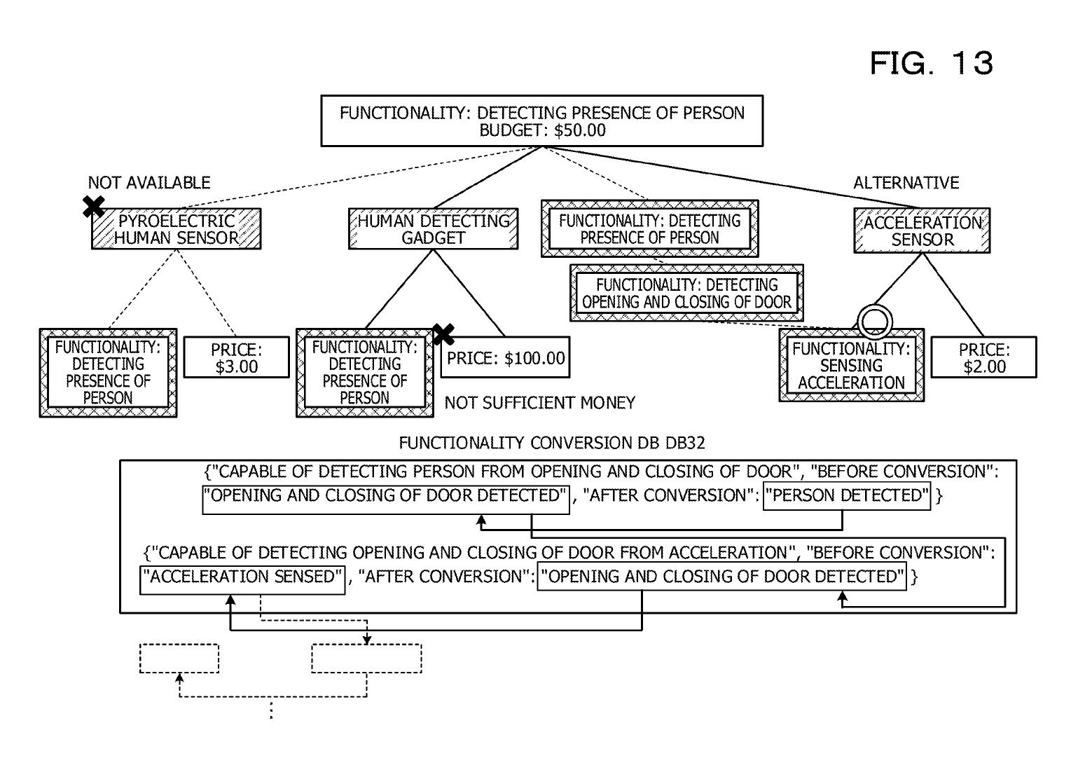

FIG. 13 illustrates an example of an alternative functionality search process. For example, in FIG. 13, a graph structure indicates a link of devices and functionalities with input data that has been input as idea data. FIG. 13 illustrates a variety of DBs.

A device having a functionality of “detecting presence of person” may be now be searched for with a budget of “5000 yen”. The budget is quality characteristics. If the device name 22b is “human detecting gadget”, “10000 yen” is stored as the price for the characteristics 22c in the device DB 22. If the device name 22b is an “acceleration sensor”, “200 yen” is stored as the price for the characteristics 22c. The device name 22b “pyroelectric human sensor” is not stored. A device “human detecting gadget” is associated with a functionality of “detecting presence of person” in the device-functionality DB 24. A device “acceleration sensor” is associated with a functionality of “sensing acceleration”.

In this circumstance, the device searching unit 13 may search for a device having a functionality of “detecting presence of person”. The “human detecting gadget” is stored in the device DB 22. The “human detecting gadget” is stored in the device-functionality DB 24 and is a device having the functionality of “detecting presence of person”. The “human detecting gadget” is thus searched for as a device having the functionality of “detecting presence of person”. Since the “pyroelectric human sensor” is not stored in the device DB 22, the “pyroelectric human sensor”, even though having the functionality of “detecting presence of person”, is not searched for.

For example, the device “human detecting gadget” searched has a prices of “10000 yen” and does not satisfy the budget of “5000 yen”.

Even if a device having the particular functionality of “detecting presence of person” is searched for, that device may fail to satisfy the quality characteristics. In such a case, the alternative functionality searching unit 31 converts the particular functionality into another functionality different from the particular functionality using the functionality conversion DB 32. The functionality conversion DB 32 associates a pre-conversion functionality of “detecting opening and closing of door” with a post-conversion functionality of “detecting presence of person”. For example, this indicates that “detecting opening and closing of door” may be converted into “detecting presence of person”. The functionality conversion DB 32 thus associates a pre-conversion functionality of “sensing acceleration” with a post-conversion functionality of “detecting opening and closing of door”. For example, this indicates that “sensing acceleration” may be converted into “detecting opening and closing of door”. Using the functionality conversion DB 32, the alternative functionality searching unit 31 converts the particular functionality into another functionality different from the particular functionality by tracing from the particular functionality of “detecting presence of person” to the functionality of “detecting opening and closing of door”, and from the functionality of “detecting opening and closing of door” to the functionality of “sensing acceleration”.

The device searching unit 13 searches the device-functionality DB 24 for a device having a functionality having a converted different functionality. For example, the device searching unit 13 searches for an “acceleration sensor” as a device having the functionality of “sensing acceleration”. The “acceleration sensor” as a found device has a price of “200 yen”, and thus satisfies the budget of “5000 yen”.

In this way, even if a device having a particular functionality is not hit, or a device, if successfully hit, fails to satisfy the quality characteristics, the information processing apparatus 1 replaces the particular functionality with another functionality. A device having the another functionality is thus presented (recommended) as a device having the particular functionality.

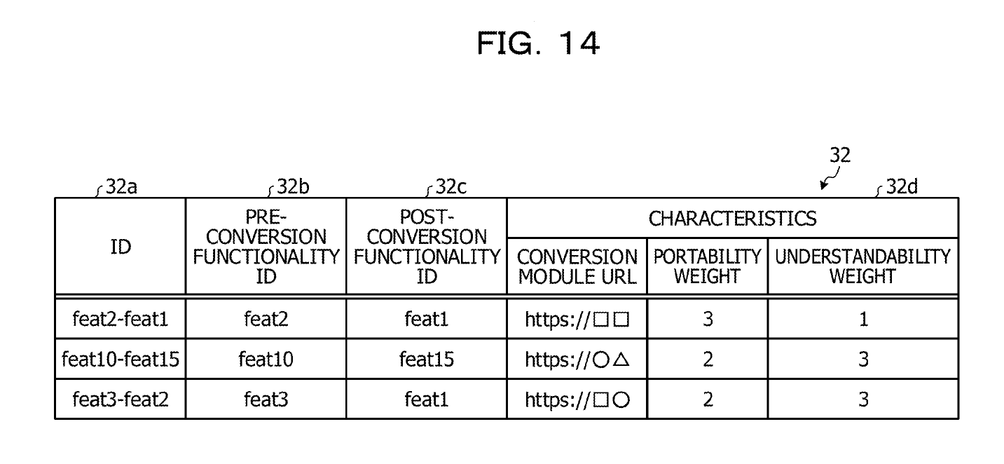

FIG. 14 illustrates an example of a data structure of the functionality conversion DB 32. The functionality conversion DB 32 stores an ID 32a, a pre-conversion functionality ID 32b, a post-conversion functionality ID 32c, and characteristics 32d in association with each other. The ID 32a is an identifier identifying a pre-conversion functionality-post-conversion functionality. The pre-conversion functionality-post-conversion functionality indicates an association between a pre-conversion functionality and a post-conversion functionality, and means that it is possible to convert the pre-conversion functionality into the post-conversion functionality. The pre-conversion functionality ID 32b is an ID of a pre-conversion functionality. The post-conversion functionality ID 32c is an ID of a post-conversion functionality. The characteristics 32d stores a variety of characteristics related to the functionality conversion. The characteristics 32d stores a conversion module URL, for example. The conversion module URL indicates a URL of a conversion module that converts functionalities. For example, when a functionality of “detecting number of steps” is converted into a functionality of “sensing acceleration”, the conversion URL indicates a URL in which a module (program) that converts “acceleration” to the “number of steps” is presented to the public. The functionality conversion DB 32 is generated before the service operation of the information processing apparatus 1.

For example, if the ID 32a is “feat2-feat1”, “feat2” is stored as the pre-conversion functionality ID 32b, and “feat1” is stored as the post-conversion functionality ID 32c. For example, the ID 32a stores an association between “detecting opening and closing of door” indicating “feat2” and “detecting presence of person” indicating “feat1”.

A device or an API having a particular functionality may be difficult to search for, or a device or API having the particular functionality, found in the search, may fail to satisfy predetermined quality characteristics. In such a case, the alternative functionality searching unit 31 may convert the particular functionality into another functionality different from the particular functionality using the functionality conversion DB 32. However, if a device or API having a particular functionality is difficult to search for, or a device or API having the particular functionality, found in the search, fails to satisfy predetermined quality characteristics, the alternative functionality searching unit 31 may convert the particular functionality into another functionality different from the particular functionality by abstracting a word forming the particular functionality. “Abstracting the word” means that a specific concept is abstracted to a word in a generic concept.

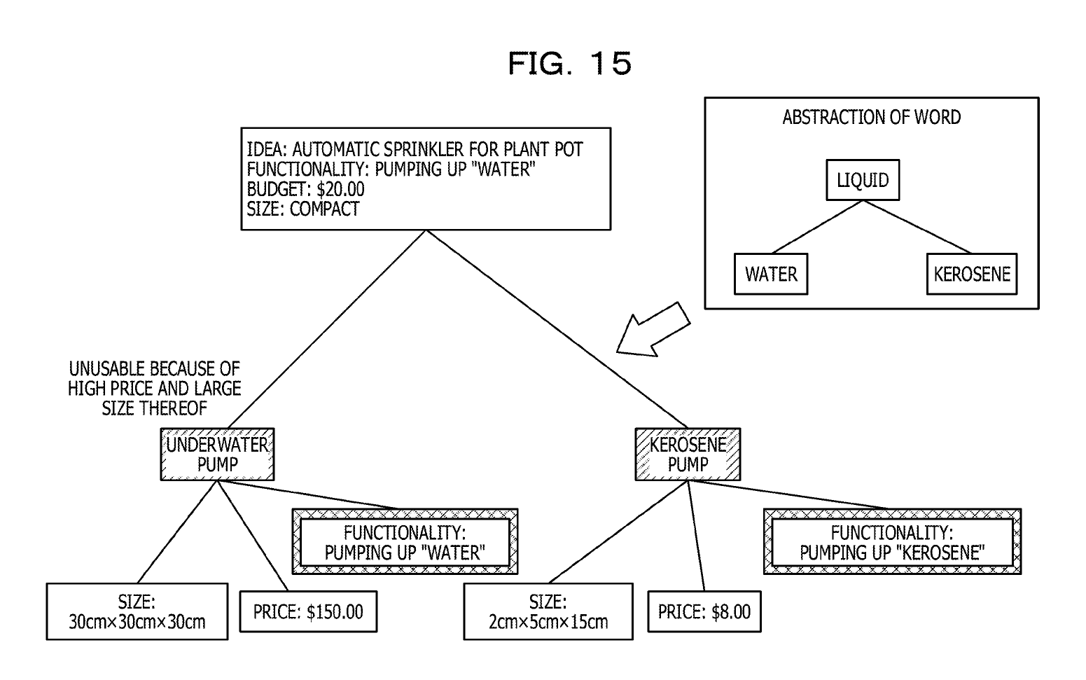

As another example of the alternative functionality search, the alternative functionality searching unit 31 converts the particular functionality into another functionality different from the particular functionality by taking the abstraction of a word forming the particular functionality. FIG. 15 illustrates the example of the alternative functionality. Referring to FIG. 15, a graph structure indicates the link of devices and functionalities with input data when the idea data is input as the input data. FIG. 15 illustrates a variety of DBs.

For example, when the budget is “2000 yen” and the size is “compact thing”, a device having a functionality of “pumping up water” is searched for. The budget and size are quality characteristics. If the device name 22b is an “underwater pump”, the device DB 22 stores “15000 yen” as a price in the characteristics 22c, and “30 cm×30 cm×30 cm” as a size in the characteristics 22c. If the device name 22b is a “kerosene pump”, “800 yen” is stored as a price in the characteristics 22c, and “2 cm×5 cm×15 cm” is stored as a size in the characteristics 22c. The device-functionality DB 24 associates the “underwater pump” as a device with the functionality of “pumping up water”, and associates the “kerosene pump” with the functionality of “pumping up kerosene”.

Under such circumstance, the device searching unit 13 searches for a device having the functionality of “pumping up water”. For example, the “underwater pump” is stored in the device DB 22. The “underwater pump” is a device that is stored in the device-functionality DB 24 and has the functionality of “pumping up water”. The “underwater pump” is thus searched for as a device having the functionality of “pumping up water”.

However, the found device “underwater pump” has a price of “15000 yen”, and does not satisfy the budget of “2000 yen”.

Therefore, the alternative functionality searching unit 31 converts a particular functionality into another functionality different from the particular functionality by accounting for abstracting a word forming the particular functionality of “pumping up water”. For example, it is assumed that the words “water” and “kerosene” are abstracted into a broader word “liquid”. Abstraction of such words may be pre-stored on the DB. Through word abstraction, the alternative functionality searching unit 31 changes from “water” to “kerosene”, and converts the particular functionality of “pumping up water” into another functionality of “pumping up kerosene”.

The device searching unit 13 searches the device-functionality DB 24 for a device having another functionality subsequent to the conversion. For example, the device searching unit 13 searches for a “kerosene pump” as a device having the functionality of “pumping up kerosene”. The found device “kerosene pump” has a price of “800 yen”, and satisfies the budget of “2000 yen”. Further, the “kerosene pump” is smaller in size than the “underwater pump”, and thus satisfies the size “compact thing”.

If a device having a particular functionality is not found in the search, or a device, found in the search, fails to satisfy the quality characteristics, the information processing apparatus 1 converts the particular functionality to another functionality. For this reason, a device having another functionality is presented (recommended) as a device having the particular functionality.

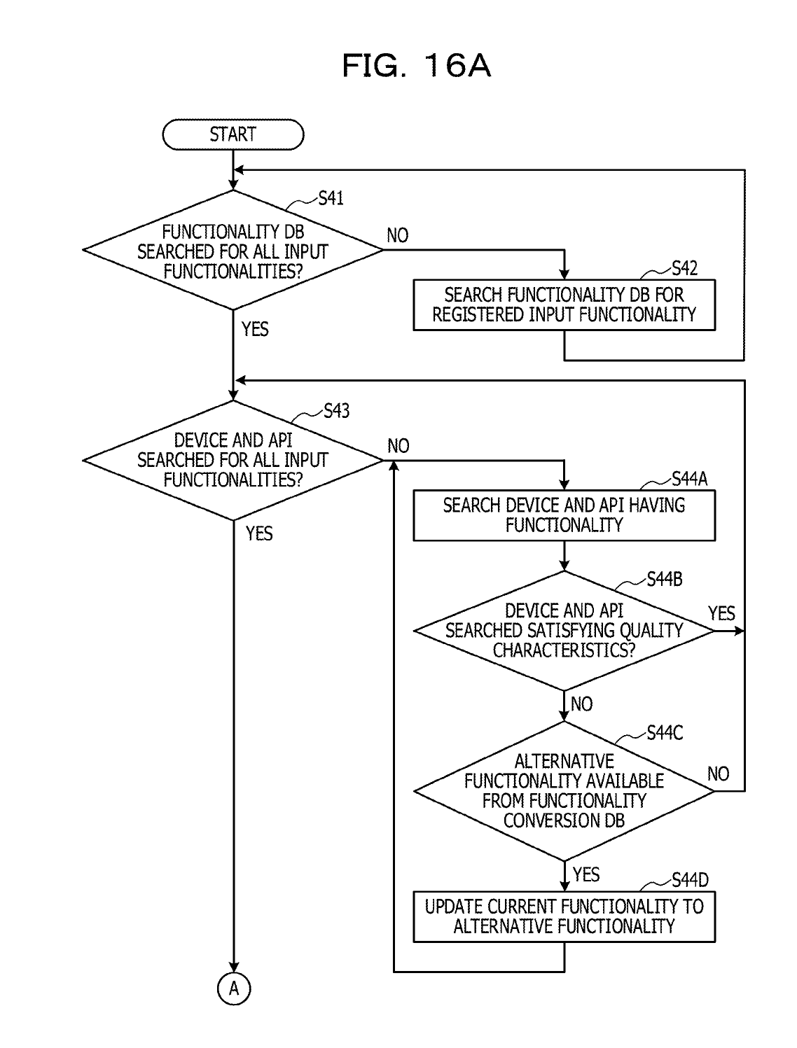

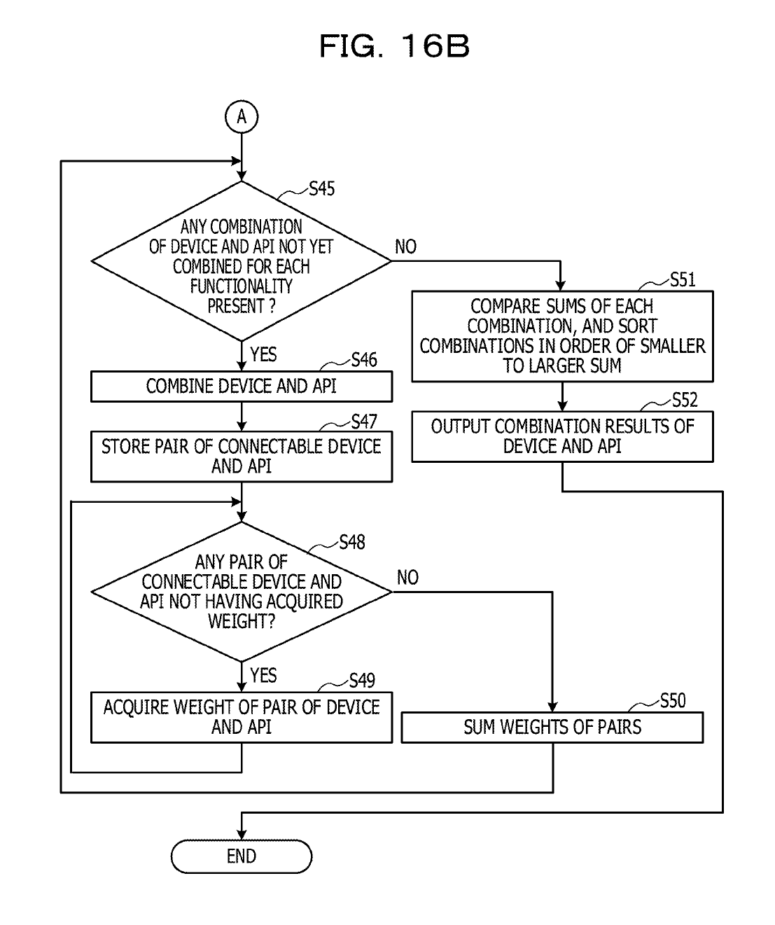

FIGS. 16A and 16B illustrate an example of a combination determination process including the alternative functionality search process.

Referring to FIGS. 16A and 16B, the functionality searching unit 12 receives multiple functionalities contained in the idea determines whether the functionality DB 21 has been searched for all input functionalities (operation S41). If the functionality searching unit 12 determines that the functionality DB 21 has not yet been searched for all input functionalities (no branch from operation S41), the functionality searching unit 12 determines whether an input functionality has been registered in the functionality DB 21 (operation S42). The functionality searching unit 12 returns to operation S41 to determine an input functionality.

If the functionality searching unit 12 determines that the functionality DB 21 has been searched for all input functionalities (yes branch from operation S41), the device searching unit 13 determines whether a device has been searched for each of all input functionalities. In addition, the API searching unit 14 determines whether an API has been searched for each of all input functionalities (operation S43). For example, the device searching unit 13 searches the device-functionality DB 24 for each device having a functionality regarding each of all functionalities. The API searching unit 14 searches the API-functionality DB 25 for each API having a functionality regarding each of all functionalities.

If it is determined that each device or API has not been searched for each of all input functionalities (no branch from operation S43), the device searching unit 13 searches for a device having the corresponding functionality. The API searching unit 14 searches for an API having the corresponding functionality (operation S44A).

The device searching unit 13 and the API searching unit 14 respectively determine whether a found device or API satisfies quality characteristics (operation S44B). If it is determined that the found device or API satisfies the quality characteristics (yes branch from operation S44B), the device searching unit 13 and the API searching unit 14 return to operation S43 to search for an unprocessed functionality.

If it is determined that the found device or API fails to satisfy the quality characteristics (no branch from operation S44B), the alternative functionality searching unit 31 determines whether the functionality conversion DB 32 has an alternative functionality (operation S44C). If the alternative functionality searching unit 31 determines that the functionality conversion DB 32 has no alternative functionality (no branch from operation S44C), the alternative functionality searching unit 31 returns to operation S43 to search for an unprocessed functionality.

If the alternative functionality searching unit 31 determines that the functionality conversion DB 32 has an alternative functionality (yes branch from operation S44C), the alternative functionality searching unit 31 updates the current functionality to the alternative functionality (operation S44D). In other words, the alternative functionality searching unit 31 converts the current functionality to another functionality different from the current functionality using the functionality conversion DB 32. The alternative functionality searching unit 31 returns to operation S44A to search for a device or API having the alternative functionality.

If it is determined that the device or API has been searched for each of all input functionalities (yes branch from operation S43), the combination determination processing unit 15 determines any of the devices and APIs corresponding to each functionality not yet combined is present (operation S45). If the combination determination processing unit 15 determines that any of the devices and APIs not combined is present (yes branch from operation S45), the combination determination processing unit 15 combines the device or API that has not yet been combined (operation S46).

The combination determination processing unit 15 stores the combinations of connectable devices and APIs in a temporary storage region of the memory 20 (operation S47). For example, the combination determination processing unit 15 stores pairs, each pair of one of devices and APIs and one of the devices and APIs, in the memory 20. A determination as to whether each device or API is connectable or not may be performed using the characteristics 22c in the device DB 22 and the characteristics 23c in the API DB 23. The combination determination processing unit 15 then proceeds to operation S48.

The combination determination processing unit 15 determines whether any of the pairs of connectable devices⋅APIs has no weight acquired (operation S48). If the combination determination processing unit 15 determines that any of the pairs has no weight acquired (yes branch from operation S48), the combination determination processing unit 15 acquires a weight for the pair of devices⋅APIs from the device—API weight DB 26 (operation S49). The combination determination processing unit 15 returns to operation S48 to perform the weight acquisition determination for weight.

If it is determined that there is no pair that has no weight acquired (no branch from operation S48), the combination determination processing unit 15 sums the weights of each of the pairs for the combinations of all functionalities (operation S50). The combination determination processing unit 15 returns to operation S45 to combine devices⋅APIs.

If it is determined in operation S45 that there are no devices and APIs which are not combined (no branch from operation S45), the combination determination processing unit 15 compares the sums of the weights of the combinations of all functionalities. The combination determination processing unit 15 sorts the combination results in the order of from a smaller sum to a larger sum (operation S51).

The output unit 16 outputs the combination results of devices⋅APIs (operation S52). The output unit 16 ends the combination determination process.

Even if a device or an API having a particular functionality is not found in the search, or a device or API found in the search fails to satisfy predetermined quality characteristics, the information processing apparatus 1 converts the particular functionality into another functionality. The information processing apparatus 1 generates multiple combinations of devices or APIs, including a device or an API having the converted another functionality. When an idea is embodied, a device or API to implement a desired functionality may not be available or may fail to satisfy the quality characteristics. In such a case, the information processing apparatus 1 efficiently finds out a combination of a device and an API that implements the desired functionality, by replacing the functionality with another functionality.

Using the functionality conversion DB 32, the information processing apparatus 1 recursively converts a particular functionality to another functionality different from the particular functionality until a device or API having a first functionality changed from a second functionality satisfies quality characteristics. By recursively converting the particular functionality into another functionality, the information processing apparatus 1 presents the device or API satisfying quality characteristics as the particular functionality.

The information processing apparatus 1 converts the particular functionality into another functionality different from the particular functionality via abstraction of a word forming the particular functionality. By converting the particular functionality into the other functionality via the abstraction of the word, the information processing apparatus 1 presents a device or API satisfying quality characteristics as the particular functionality.

The information processing apparatus 1 may search for a device or API having each functionality contained in an idea, and determines a combination of the device and API found in the search. If a device or API having the functionality is not found in the search, or if a found device or API fails to satisfy quality characteristics, the information processing apparatus 1 may perform the following process. For example, the information processing apparatus 1 recursively converts the functionality into another functionality (replaces the functionality with another functionality) using the functionality conversion DB 32. As the alternative functionalities increase, the information processing apparatus 1 performs a comprehensive search on functionalities ranging from the contents of a desired idea to an alternative functionality that may be actually used. The search operation thus involves load and time. For this reason, the information processing apparatus 1 may stop a recursive alternative process in succession to an alternative functionality if the alternative functionality has a low usage frequency in the past.

For example, in the case of the alternative functionality having a low past usage frequency, the information processing apparatus 1 may not necessarily have to continue the recursive alternative process in succession to the alternative functionality.

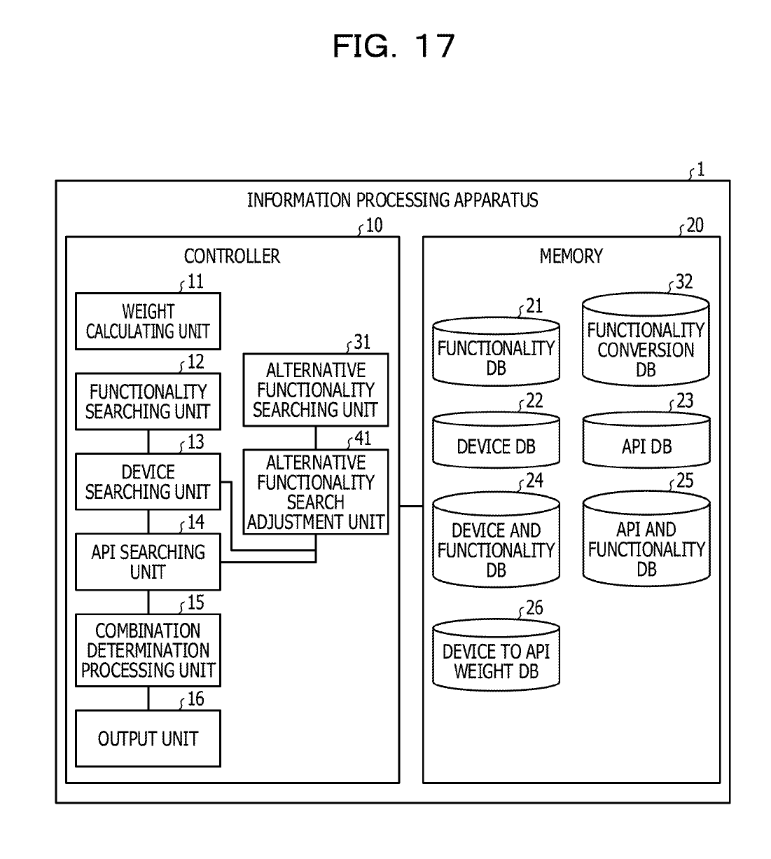

FIG. 17 is a functional block diagram of the information processing apparatus. Elements identical to the information processing apparatus of FIG. 17 are designated with the same reference numerals as in the information processing apparatus 1 of FIG. 12, and the discussion of the identical elements and operation thereof is omitted herein. The information processing apparatus of FIG. 17 is different from the information processing apparatus of FIG. 12 in that the information processing apparatus of FIG. 17 additionally includes an alternative functionality search adjustment unit 41.

The alternative functionality search adjustment unit 41 adjusts an alternative functionality search process. If the current functionality is converted into another functionality by the alternative functionality searching unit 31, the alternative functionality search adjustment unit 41 acquires a past usage count of the device or API searched according to the current functionality. The alternative functionality search adjustment unit 41 acquires the usage count of uses of the alternative functionality via the current functionality. The alternative functionality search adjustment unit 41 selects a functionality indicating a maximum count acquired. If the selected functionality is not the current functionality, the alternative functionality search adjustment unit 41 updates the alternative functionality with the current functionality, and continuously adjusts the alternative functionality search process. If the selected functionality is the current functionality, the alternative functionality search adjustment unit 41 causes the device searching unit 13 and the API searching unit 14 to perform the search operation on the current functionality. If the alternative functionality has a lower usage frequency, the alternative functionality search adjustment unit 41 does not continue to perform the recursive alternative process in succession to the alternative functionality.

The usage count of a device or API searched according to the current functionality and the count of selections of the alternative functionality via the current functionality may be stored in the characteristics 21c in the functionality DB 21 (see FIG. 3).

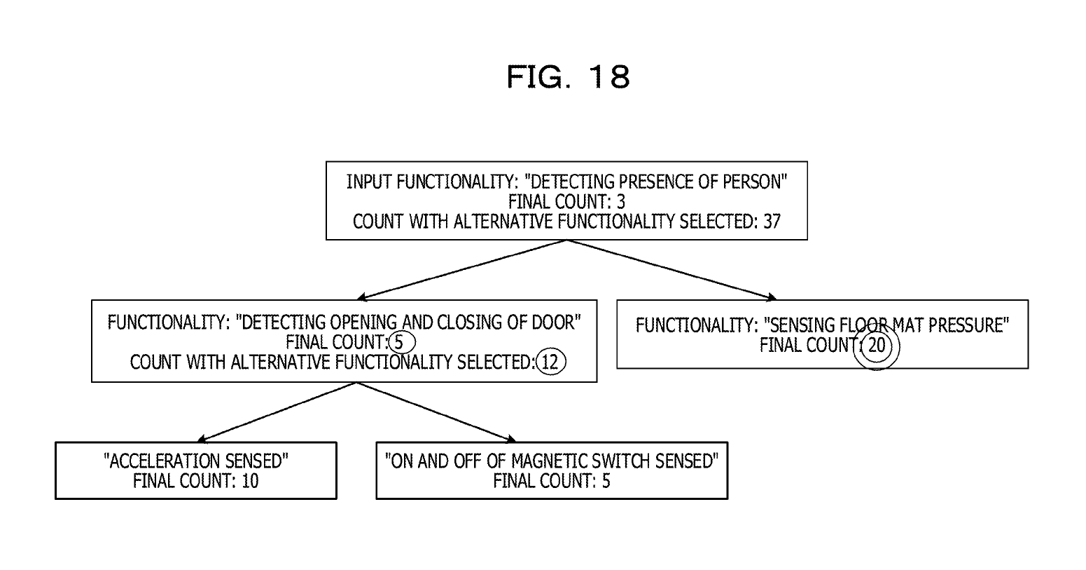

FIG. 18 illustrates an example of the alternative functionality search adjustment process. If the functionality name 21b is “detecting presence of person”, the functionality DB 21 stores “3” as a usage count of a device that has been searched for according the functionality in the characteristics 21c, and “37” as a count at which another alternative functionality is selected via the functionality in the characteristics 21c. If the functionality name 21b is “detecting opening and closing of door”, the functionality DB 21 stores “5” as a usage count of a device that has been searched for according to a functionality in the characteristics 21c, and “12” as a count at which another alternative functionality is selected via the functionality in the characteristics 21c. If the functionality name 21b is “sensing floor mat pressure”, the functionality DB 21 stores “20” as a usage count of a device that has been searched for according to a functionality in the characteristics 21c, and “0” as a count at which another alternative functionality is selected via the functionality in the characteristics 21c.

Under this circumstance, the alternative functionality searching unit 31 may search for a device or API having a current functionality of “detecting presence of person”, but a device or API found in the search may fail to satisfy predetermined quality characteristics. Using the functionality conversion DB 32, the alternative functionality searching unit 31 converts the current functionality of “detecting presence of person” into another functionality different from the particular functionality. For example, the alternative functionality searching unit 31 may convert the current functionality of “detecting presence of person” into a functionality of “detecting opening and closing of door”. The alternative functionality searching unit 31 may convert the current functionality of “detecting presence of person” into a functionality of “sensing floor mat pressure”.

The alternative functionality search adjustment unit 41 acquires a usage count of a device or API used in the past and searched according to the current functionality of “detecting presence of person”. For example, the alternative functionality search adjustment unit 41 acquires a usage count of “3”. The alternative functionality search adjustment unit 41 acquires a count of selections of an alternative functionality via the current functionality of “detecting presence of person”. The alternative functionality search adjustment unit 41 acquires a count of “37”, for example. Therefore, since the usage count of “3” for the current functionality is smaller than the count “37” of the alternative functionality, the alternative functionality search adjustment unit 41 updates the alternative functionality of “detecting opening and closing of door” and the alternative functionality of “sensing floor mat pressure” to the current functionality, and continues to adjust the alternative functionality search adjustment process.

If the current functionality is “detecting opening and closing of door”, the alternative functionality search adjustment unit 41 acquires the past usage count of a device or API searched for according to the current functionality. The alternative functionality search adjustment unit 41 acquires a past usage count of “5”, for example. The alternative functionality search adjustment unit 41 acquires a count of selections of an alternative functionality via the current functionality. The alternative functionality search adjustment unit 41 acquires a count of selections of “12”, for example. If the current functionality is “sensing floor mat pressure”, the alternative functionality search adjustment unit 41 acquires the past usage count of a device or API searched for according to the current functionality. The alternative functionality search adjustment unit 41 acquires a past usage count of “20”, for example. In addition, the alternative functionality search adjustment unit 41 acquires a count of selections of an alternative functionality via the current functionality. The alternative functionality search adjustment unit 41 acquires a count of selections of “0”, for example. The alternative functionality search adjustment unit 41 selects a functionality having the highest count from among the acquired counts. For example, the current functionality of “sensing floor mat pressure” is selected as the current functionality indicative of the highest count. Therefore, since the selected functionality of “sensing floor mat pressure” is the current functionality, the alternative functionality search adjustment unit 41 causes the device searching unit 13 and the API searching unit 14 to make the search operation on the current functionality of “sensing floor mat pressure”. For example, the alternative functionality search adjustment unit 41 omits the search operation on the current functionality of “detecting opening and closing of door” and on the alternative functionality via the current functionality.

In this way, the alternative functionality search adjustment unit 41 does not continue the recursive alternative process in succession to the alternative functionality having a low past usage frequency. The alternative functionality search adjustment unit 41 thus omits the alternative process in succession to the alternative functionality having a low usage frequency. This reduces the load and time involved in the search process of the alternative functionality.

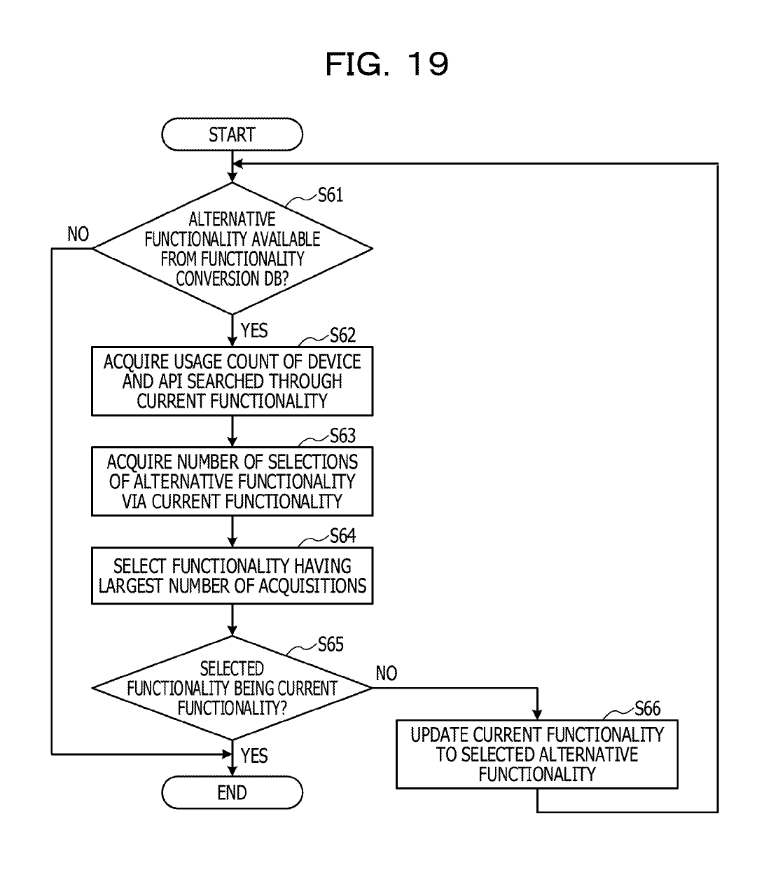

FIG. 19 is a flowchart illustrating the alternative functionality search adjustment process. For example, the alternative functionality searching unit 31 searches for a device having the current functionality, but there are times when the device found in the search fails to satisfy the quality characteristics.

Referring to FIG. 19, the alternative functionality searching unit 31 determines whether an alternative functionality corresponding to the current functionality is available from the functionality conversion DB 32 (operation S61). If the alternative functionality searching unit 31 determines that no alternative functionality is available (no branch from operation S61), the alternative functionality search adjustment unit 41 ends the alternative functionality search adjustment process.

If the alternative functionality searching unit 31 determines that an alternative functionality is available (yes branch from operation S61), the alternative functionality search adjustment unit 41 references the functionality DB 21 and acquires the past usage count of devices⋅APIs searched according to the current functionality (operation S62). The alternative functionality search adjustment unit 41 further references the functionality DB 21 and acquires the count of selections of the alternative functionality via the current functionality (step S63).

The alternative functionality search adjustment unit 41 selects a functionality having a largest count of acquisitions (operation S64). The alternative functionality search adjustment unit 41 determines whether the selected functionality is the current functionality (operation S65). If the alternative functionality search adjustment unit 41 determines that the selected functionality is not the current functionality (no branch from operation S65), the alternative functionality search adjustment unit 41 updates the current functionality with the selected alternative functionality (operation S66). The alternative functionality search adjustment unit 41 then returns to operation S61 to convert the current functionality to another functionality.

If the alternative functionality search adjustment unit 41 determines that the selected functionality is the current functionality (yes branch from operation S65), the alternative functionality search adjustment unit 41 ends the alternative functionality search adjustment process.

The information processing apparatus 1 uses the past usage frequency of the current functionality and another functionality, and omits the functionality conversion to yet another functionality different from the other functionality via the other functionality having a lower usage frequency. In this configuration, the information processing apparatus 1 reduces load and time involved in the functionality conversion process to the alternative functionality by omitting the functionality conversion to the alternative functionality.

The alternative functionality search adjustment unit 41 uses the past usage frequency of the current functionality and another functionality, and omits the functionality conversion to yet another functionality different from the other functionality via the other functionality having a lower usage frequency. However, the operation of the alternative functionality search adjustment unit 41 is not limited to this operation. The alternative functionality search adjustment unit 41 may omit the functionality conversion using portability between one functionality and another, and understandability between one functionality and another. The portability between functionalities refers to the degree of portability according to which a capability unique to a particular functionality is imported to another functionality effectively and efficiently. For example, “opening and closing of door” may be converted in functionality to “detecting presence of person”. Since “opening and closing of door” may be caused by an animal or wind other than a person, “detecting presence of human” is not effectively detected from “Opening and closing of door”. Accordingly, when the functionality conversion is performed from “Opening and closing door” to “Detecting presence of person”, the portability between the functionalities is lower. For example, the alternative functionality search adjustment unit 41 may omit the functionality conversion of which the portability is lower by referencing the portability between functionalities. The portability between functionalities may be stored in a portability weight column in the characteristics 32d in the functionality conversion DB 32. Any value may be input as a set value of the portability. For example, a portability weight of “1” may indicate a higher portability value, and a portability weight of “3” may indicate a lower portability value. The understandability between functionalities refers to the degree of easiness or difficulty to understand a hardware process or a software process in converting a particular functionality to another functionality. For example, the alternative functionality search adjustment unit 41 may omit the functionality conversion that involves a lower level of understandability, using the understandability between functionalities. The understandability between functionalities may be stored in an understandability weight column in the characteristics 32d on the functionality conversion DB 32. Any value may be input as a set value of an understandability weight. For example, a understandability weight of “1” may indicate a more understandable index, and a portability weight of “3” may indicate a less understandable index.

Distribution and integration of the information processing apparatus 1 may not be limited to those illustrated in the drawings. Whole or part of the information processing apparatus 1 may be distributed or integrated functionally or physically by any unit depending on a variety of loads and usage status. For example, the device searching unit 13 and the API searching unit 14 may be integrated into one unit. The memory 20 may be coupled as an external device to the information processing apparatus 1 via a network.

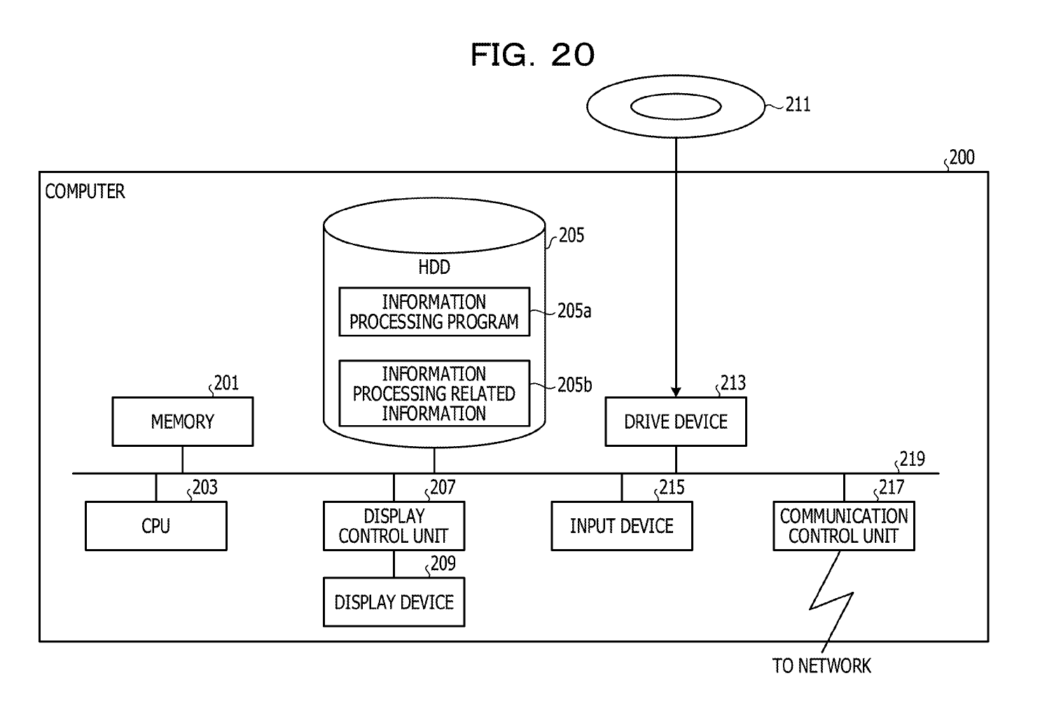

The processes described above may performed by a personal computer or a workstation that executes a program which is prepared in advance. FIG. 20 illustrates an example of a computer 200 that executes an information processing program. Therefore, an example of the computer 200 which executes the information processing program that implements the same functionalities as those of the information processing apparatus 1 of FIG. 1 is described hereinafter.

Referring to FIG. 20, the computer 200 includes a CPU 203 that performs a variety of arithmetic processes, an input device 215 that receives an input of data from the user, and a display control unit 207 that controls a display device 209. The computer 200 further includes a drive device 213 that reads a program from a storage device, and a communication control unit 217 that exchanges data with another computer via the network. The computer 200 further includes a memory 201 that temporarily stores a variety of information, and a hard disk drive (HDD) 205. The memory 201, the CPU 203, the HDD 205, the display control unit 207, the drive device 213, the input device 215, and the communication control unit 217 are interconnected to each other via a bus 219.

The drive device 213 is used with a removable disk 211. The HDD 205 stores an information processing program 205a and information processing related information 205b.

The CPU 203 reads and expands the information processing program 205a on the memory 201 to execute it as a process. Such a process corresponds to each functional element of the information processing apparatus 1. The information processing related information 205b corresponds to the functionality DB 21, the device DB 22, the API DB 23, the device-functionality DB 24, the API-functionality DB 25, and the device-API weight DB 26. Further, for example, the removable disk 211 stores a variety of information, such as the information processing program 205a.

The information processing program 205a may not necessarily have to be stored in the HDD 205 from the beginning. For example, the information processing program 205a may be stored in a “portable media” such as a flexible disk (FD), a compact disk read only memory (CD-ROM), a digital versatile disk (DVD), a magneto-optical disk, and an IC card. The computer 200 may read the information processing program 205a from the portable media and execute the information processing program 205a.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing apparatus comprising:
a memory; and
a processor coupled to the memory,
wherein the processor:
acquires a plurality of functionalities that a system uses to implement a predetermined idea;
searches functionality information, which associates devices with functionalities and associates application programming interfaces (APIs) with functionalities, for one or more devices or one or more APIs having the respective acquired functionalities;
generates a plurality of first combinations including at least two ones of the one or more devices and the one or more APIs and having the functionalities;
assesses each of the first combinations in accordance with an assessment function in which the first combinations are weighted with particular elements; and
presents the first combinations in accordance with assessment values obtained in assessment to select a first combination to be used in the system.

2. The information processing apparatus according to claim 1, wherein a first combination having a minimum assessment value is selected as the first combination to be used in the system.

3. The information processing apparatus according to claim 1, wherein the first combinations comprise one or more of second combinations each including at least one of a combination of a device and a device, a combination of a device and an API, and a combination of an API and an API, and
wherein weights on the one or more of second combinations are summed, and a resulting sum is presented as the assessment values of the first combinations.

4. The information processing apparatus according to claim 1, wherein the first combinations comprise one or more of second combinations each including at least one of a combination of a device and a device, a combination of a device and an API, and a combination of an API and an API,
wherein the particular elements include at least one of a frequency of use of the second combinations, a number of the second combinations, and a communication interface of the second combinations.

5. The information processing apparatus according to claim 1, wherein the processor:
converts, if one or more devices or one or more APIs having a particular functionality out of the functionalities are not found in searching or if the one or more devices or the one or more APIs having the particular functionality which is found in the searching, fails to satisfy a quality characteristic, the particular functionality into another functionality different from the particular functionality; and
generates a plurality of first combinations including at least two ones of one or more devices or one or more APIs having the another functionality.

6. The information processing apparatus according to claim 5, wherein the processor recursively converts the particular functionality into the another functionality using conversion information that associates a first functionality prior to a conversion with a second functionality subsequent to the conversion until one or more devices or one or more APIs having the second functionality converted from the first functionality satisfies the quality characteristic.

7. The information processing apparatus according to claim 5, wherein the processor converts the particular functionality into the another functionality via abstracting a word that forms the particular functionality.

8. The information processing apparatus according to claim 5, wherein the processor omits a functionality conversion of a functionality that passes through another functionality having a low frequency of uses, using frequency information that indicates past usage frequency of the particular functionality and the another functionality.

9. An information processing method comprising:
acquiring, by a computer, a plurality of functionalities that a system uses to implement a predetermined idea;
searching functionality information, which associates devices with functionalities and associates application programming interfaces (APIs) with functionalities, for one or more devices or one or more APIs having the respective acquired functionalities;
generating a plurality of first combinations including at least two ones of the one or more devices and the one or more APIs and having the functionalities;
assessing each of the first combinations in accordance with an assessment function in which the first combinations are weighted with particular elements; and
presenting the first combinations in accordance with assessment values obtained in assessment to select a first combination to be used in the system.

10. The information processing method according to claim 9, wherein a first combination having a minimum assessment value is selected as the first combination to be used in the system.

11. The information processing method according to claim 9, wherein the first combinations comprise one or more of second combinations each including at least one of a combination of a device and a device, a combination of a device and an API, and a combination of an API and an API, and
wherein weights on the one or more of second combinations are summed, and a resulting sum is presented as the assessment values of the first combinations.

12. The information processing method according to claim 9, wherein the first combinations comprise one or more of second combinations each including at least one of a combination of a device and a device, a combination of a device and an API, and a combination of an API and an API,
wherein the particular elements include at least one of a frequency of use of the second combinations, a number of the second combinations, and a communication interface of the second combinations.

13. The information processing method according to claim 9, further comprising:
converting, if one or more devices or one or more APIs having a particular functionality out of the functionalities are not found in searching or if the one or more devices or the one or more APIs having the particular functionality which is found in the searching, fails to satisfy a quality characteristic, the particular functionality into another functionality different from the particular functionality; and
generating a plurality of first combinations including at least two ones of one or more devices or one or more APIs having the another functionality.

14. The information processing method according to claim 13, wherein the particular functionality is recursively converted into the another functionality using conversion information that associates a first functionality prior to a conversion with a second functionality subsequent to the conversion until one or more devices or one or more APIs having the second functionality converted from the first functionality satisfies the quality characteristic.

15. A non-transitory computer-readable recording medium recording an information processing program which causes a computer to perform operations, the operations comprising:
acquiring a plurality of functionalities that a system uses to implement a predetermined idea;
searching functionality information, which associates devices with functionalities and associates application programming interfaces (APIs) with functionalities, for one or more devices or one or more APIs having the respective acquired functionalities;
generating a plurality of first combinations including at least two ones of the one or more devices and the one or more APIs and having the functionalities;
assessing each of the first combinations in accordance with an assessment function in which the first combinations are weighted with particular elements; and
presenting the first combinations in accordance with assessment values obtained in assessment to select a first combination to be used in the system.

16. The non-transitory computer-readable recording medium according to claim 15, wherein a first combination having a minimum assessment value is selected as the first combination to be used in the system.

17. The non-transitory computer-readable recording medium according to claim 15, wherein the first combinations comprise one or more of second combinations each including at least one of a combination of a device and a device, a combination of a device and an API, and a combination of an API and an API, and
wherein weights on the one or more of second combinations are summed, and a resulting sum is presented as the assessment values of the first combinations.

18. The non-transitory computer-readable recording medium according to claim 15, wherein the first combinations comprise one or more of second combinations each including at least one of a combination of a device and a device, a combination of a device and an API, and a combination of an API and an API,
wherein the particular elements include at least one of a frequency of use of the second combinations, a number of the second combinations, and a communication interface of the second combinations.

19. The non-transitory computer-readable recording medium according to claim 15, further comprising:
converting, if one or more devices or one or more APIs having a particular functionality out of the functionalities are not found in searching or if the one or more devices or the one or more APIs having the particular functionality which is found in the searching, fails to satisfy a quality characteristic, the particular functionality into another functionality different from the particular functionality; and
generating a plurality of first combinations including at least two ones of one or more devices or one or more APIs having the another functionality.

20. The non-transitory computer-readable recording medium according to claim 19, wherein the particular functionality is recursively converted into the another functionality using conversion information that associates a first functionality prior to a conversion with a second functionality subsequent to the conversion until one or more devices or one or more APIs having the second functionality converted from the first functionality satisfies the quality characteristic.
